(19) United States
(12) Patent Application Publication
(10) Pub. No.: US 2026/0002842 A1
(43) Pub. Date: Jan. 1, 2026

(54) Water Vapor Die Temperature Controls for Two-Phase Jet Impingement Testing

(71) Applicant: Intel Corporation, Santa Clara, CA (US)

(72) Inventors: Sami ALELYANI, Phoenix, AZ (US); Joseph PETRINI, Gilbert, AZ (US); Paul DIGLIO, Gaston, OR (US); Kelly LOFGREEN, Phoenix, AZ (US)

(21) Appl. No.: 18/755,771

(22) Filed: Jun. 27, 2024

(51) Int. Cl. G01M 99/00; G01K 7/16; G01N 17/00

(52) U.S. Cl. CPC G01M 99/002; G01K 7/16; G01N 17/002

(57) ABSTRACT

The various aspects are directed to a two-phase jet impingement testing system having a water circulation system configured to convey pressurized heated water produced by a primary water heater and, optionally, by a secondary heater. A testing chamber is connected to the water circulation system, and the testing chamber includes a support for a device under test, a first inlet configured to introduce heated water from the primary water heater into the testing chamber, a second inlet configured to introduce a secondary heated water into the testing chamber to modulate the saturation pressure and temperature.

### BACKGROUND

For integrated circuit design and fabrication, the need to improve manufacturing processes and lower costs are constant challenges. Various testing techniques are used during the semiconductor manufacturing process, such as functional testing for the basic functions of ICs, structural testing for identifying physical defects, parametric testing for analyzing chip performance under varying conditions, and reliability testing for assessing chip durability and longevity. One type of testing that is commonly performed on semiconductor ICs and chips is thermal cycling testing, which may be performed using two-phase jet impingement testing.

In a two-phase jet impingement system, a high heat removal rate may be achieved with moderate pressure losses using one or more jets impinge liquid onto a heated surface, where it boils. This cooling approach can achieve high heat transfer coefficients in both single- and two-phase operations. The impinging jets serve to locally enhance convective heat transfer and to actively supply liquid to the boiling surface. The two-phase jet impingement cooling system chamber will modulate saturation pressure (and saturation temperature) by controlling the system pressure, which is currently achieved by injecting air into the system, directly or indirectly.

However, the current two-phase jet impingement cooling systems may have limitations and drawbacks, which include the use of injecting air impacting the system's low pressure (i.e., vacuum) and significantly reducing/eliminating the effectiveness of running multiple testing units in parallel. The need for separate systems for each device under test (DUT) may lead to higher capital costs. In addition, the use of valves in the injected air system may lead to slower response times and decreased efficiency.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows an exemplary representation of a two-phase jet impingement testing system according to an aspect of the present disclosure;

FIG. 2 shows an exemplary representation of a two-phase jet impingement testing system according to another aspect of the present disclosure;

FIG. 3 shows an exemplary representation of a two-phase jet impingement testing system according to another aspect of the present disclosure;

FIG. 4 shows an exemplary representation of a two-phase jet impingement testing system according to another aspect of the present disclosure;

FIG. 5 shows an exemplary flow diagram of a system two-phase jet impingement testing system according to an aspect of the present disclosure;

FIG. 6 shows a simplified flow diagram for an exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

According to the present disclosure, a present two-phase jet impingement testing system (also presently referred to as the testing system) is configured to locally control the vapor quality (i.e., vapor content) inside the testing chamber by modulating the saturation pressure/temperature therein. The term “saturation” defines the condition in which the mixture of vapor and liquid can exist together. The temperature at which vaporization (i.e., boiling) starts to occur for a given pressure is called the saturation temperature, and the pressure at which vaporization starts to occur for a given temperature is called the saturation pressure.

In an aspect, the saturation pressure/temperature may modulated through the adjustment of a bypass flow of additional or “secondary” heated water into the testing chamber. When pressurized heated water is introduced into a low-pressure environment, i.e., the testing chamber, the water temperature decreases to the saturation temperature, and a high percentage (e.g. an amount in the range of 5 to 20 percent) of the heated water may turn into water vapor due to the pressure change, since the introduced heated water temperature is higher than the saturation temperature inside the testing chamber; for example, the heated water temperature at an inlet may be 150° C. and the saturation temperature in the testing chamber may be 70° C. This vapor formation increases the testing chamber's pressure, which increases the saturation temperature. Accordingly, the present testing system may be modulated by the heated water using (1) a bypass flow and/or (2) a change in inlet water temperature. By controlling the vapor content (i.e., quality) inside the testing chamber (e.g. a vaper content in the range of 5 to 20 percent), the testing chamber's saturation pressure is controlled, and consequently, the die temperature. The water vapor in the testing chamber may be converted back into liquid after exiting the testing chamber using an inline condensation system that minimizes the impact on the testing system's (downstream) pressure.

In another aspect, the present two-phase jet impingement testing system may enable a reduction in test duration, with thermally superior and more accurate product categorization. In addition, a multi-testing chamber design may substantially reduce equipment requirements and extend the lifetime of vacuum pumps, which may ultimately lead to a reduction in overall testing costs.

The present disclosure provides a testing system having a water circulation system configured to convey pressurized heated water and cooling water produced by a primary water heater. A testing chamber is connected to the water circulation system, and the testing chamber includes a support for a device under test, a first inlet configured to introduce heated water from the primary water heater into the testing chamber, a second inlet configured to introduce a secondary heated water from the primary water heater, or optionally, further heated by a secondary heater, into the testing chamber, and a first outlet configured to remove heated water and water vapor from the testing chamber. In an aspect, the testing system includes a control system configured to monitor and control temperature and pressure in the testing chamber, as well as throughout the testing system. In particular, the saturation temperature and pressure may be increased in the testing chamber by the control system using the heated water from the primary water heater and/or a secondary water heater, and a temperature monitor configured to couple with a temperature sensor disposed on the device under test and monitor the thermal response of the device.

The present disclosure is also directed to a method that includes providing a die for thermal testing using a two-phase jet impingement testing system having water vaper controls that includes a testing chamber with a support for the die, a water circulation system configured to convey pressurized heated water and cooling water, and a primary water heater for producing the heated water that is connected by a first section of water conduits of the water circulation system and delivered to the testing chamber. In an aspect, the method includes positioning the die in the testing chamber on the support and introducing heated water from the primary water heater into the testing chamber, and monitoring and controlling temperature and pressure in the two-phase jet impingement testing system using a control system. In another aspect, the method includes monitoring and controlling temperature and pressure in the testing chamber and introducing secondary heated water from the primary water heater and/or a secondary heater to increase and control a saturation temperature and pressure for the heated water in the testing chamber using the control system, and monitoring and recording a temperature for the die.

The present disclosure is further directed to a testing system including a water circulation system configured to convey pressurized heated water to a plurality of testing chambers connected by the water circulation system. In an aspect, the pressurized heated water is produced by a primary water heater and optionally by a plurality of secondary water heaters. In an aspect, each testing chamber includes a support for a die under test, a first inlet configured to introduce heated water from the primary water heater into the testing chamber, a second inlet configured to introduce heated water into the testing chamber from a paired secondary water heater from the plurality of secondary water heaters, and a first outlet configured to remove heated water and water vapor from the testing chamber; a control system configured to monitor and control temperature and pressure in the plurality of testing chambers, wherein a saturation temperature and a saturation pressure are increased in each of the testing chambers independently by the control system using the heated water from its paired secondary water heater; and a temperature monitor configured to couple with a temperature sensor disposed on the die under test.

The technical advantages of the present disclosure include, but are not limited to:
(i) providing a two-phase jet impingement cooling system that eliminates the need for air injection into the system and the accompanying system pressure concerns;
(ii) providing a system that may be configured with multiple testing chambers, e.g., a parallel configuration, that may reduce the system's component requirements and its overall footprint; and
(iii) providing a reduced testing time for each die through a thermally superior process that provides more accurate product categorization.

To more readily understand and put into practical effect the present two-phase jet impingement cooling system and methods, which may provide improved thermal testing of semiconductor dies, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

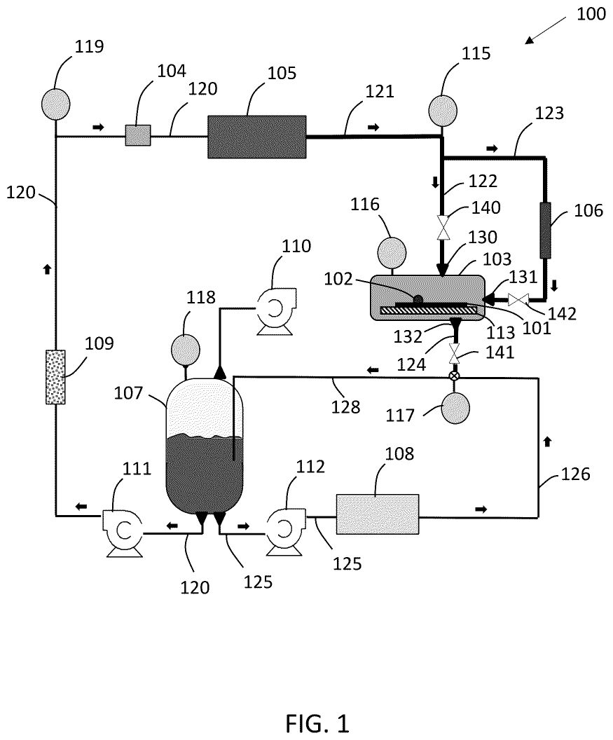

FIG. 1 shows an exemplary representation of a two-phase jet impingement testing system 100 (or testing system 100) according to an aspect of the present disclosure. In this aspect, the two-phase jet impingement testing system 100 may have a testing chamber 103 with a support 113 for holding a device under test 101, e.g., a die. The device 101 may have one or more resistance temperature detectors (RTD) 102 for providing temperature measures for the device 101 while it is being tested. The RTD 102 may be coupled with a temperature monitor (not shown), which may be part of the testing system 100. The testing chamber 103 may have a first inlet 130 for the heated water and a second inlet 131 for the heated water, and an outlet 132 for removing heated water and water vapor from the testing chamber 103. In an aspect, the first and second inlets 130 and 131, respectively, may be jet nozzles.

In this aspect, the testing system 100 may have a first section of the water circulation system for conveying heated water. A water reservoir 107 may have a first pump 110, which may be a vacuum pump that controls the pressure in the water reservoir 107, and a first conduit 120 connected to a second pump 111 that moves the water under pressure to a filter 109, a flow meter 104 and a water heater 105 (also presently referred to as the primary water heater). The water heater 105 may provide heated water to a first section of water conduits of the water circulation system that includes a second conduit 121, a third conduit 122, a fourth conduit 123, and a fifth conduit 124.

In this aspect, the third conduit 122 may have a first valve 140 that controls the flow of heated water into the first inlet 130. The fourth conduit 123, which may be configured as a bypass that leads from the third conduit 122, may have a proportional valve 142 that controls the flow of a “secondary” heated water into the second inlet 131. The fourth conduit 123 may have a small cross-sectional area (e.g., a one-quarter inch or less) for the flow of heated water and may be positioned to ensure the highest possible temperature, which will translate to a higher vapor quality (i.e., vapor content) and a faster test response. In addition, the fourth conduit 123 may be optionally provided with an auxiliary or secondary water heater 106 to provide additional heating for the secondary heated water. The secondary heated water may be used to modulate, i.e., increase or decrease, the saturation temperature and pressure in the testing chamber 103. The fifth conduit 124 may have a shutoff valve 141 that controls the flow of heated water and water vapor that may be removed from the testing chamber 103. In another aspect, as an option, the shutoff valve 141 may be used to restrict the flow and enhance the response time and may include either a proportional valve or other control valve.

In this aspect, the testing system 100 may have a second section of the water circulation system for conveying cooling water. The water reservoir 107 may be coupled to a second section of water conduits of the water circulation system that includes a sixth conduit 125 connected to a third pump 112 that moves the water under pressure to a cooler 108, which cools the water, a seventh conduit 126 that joins with the fifth conduit 124, and an eighth conduit 128 that returns the water to the water reservoir 107. The heated water and water vapor being removed from the testing chamber 103 by the fifth conduit 124 may be cooled and condensed in the eighth conduit 128 by the cooling water from the seventh conduit 126.

In this aspect, the testing system 100 may have a control system for monitoring and controlling the pressure in the testing chamber 103, as well as throughout the testing system, using a plurality of pressure sensors. For example, as shown in FIG. 1, the water reservoir 107 may have a pressure sensor 118, the first conduit 120 may have a first pressure gauge 119, the second conduit 121 may have a second pressure gauge 115, the testing chamber 103 may have a third pressure gauge 116, and the eight conduit 128 may have a fourth pressure gauge 117. It should be understood that additional pressure gauges may be placed in a testing system as may be needed by a specific system design. In addition, the control system may monitor and control the temperature throughout the testing system 100 using the heater 105, the cooler 108, and the testing chamber 103 using the first mixing valve 140, the shutoff valve 141, and the proportional valve 142.

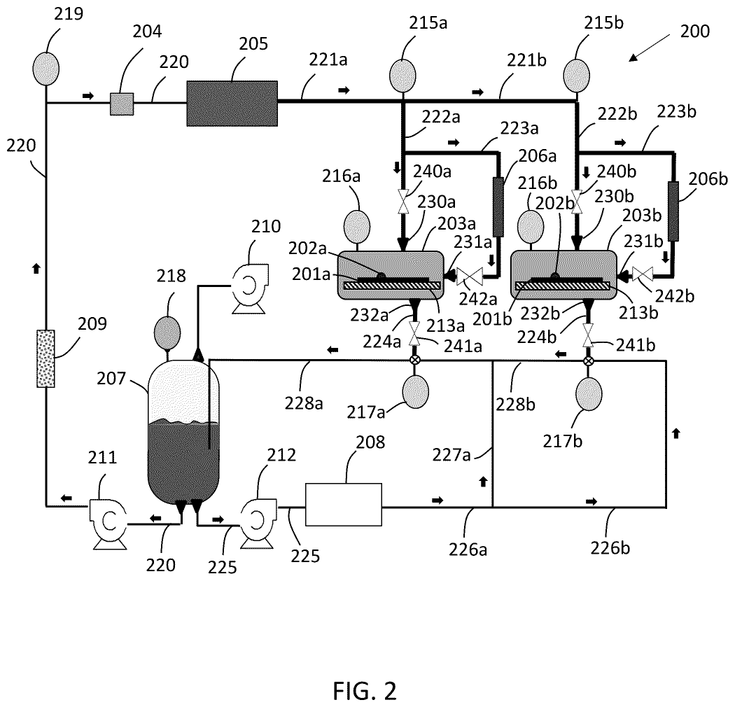

FIG. 2 shows an exemplary representation of a two-phase jet impingement testing system 200 having a plurality of testing chambers according to another aspect of the present disclosure. For example, the two-phase jet impingement testing system 200 may include a first testing chamber (ftc) 203a and a second testing chamber (stc) 203b. In this aspect, the first testing chamber 203a may have an ftc-support 213a for holding a first device under test 201a, e.g., a die. The first device 201a may have one or more first resistance temperature detectors (RTD) 202a for providing temperature measures for the first device 201a while it is being tested. The first RTD 202a may be coupled with a temperature monitor (not shown), which may be part of the testing system 200. The first testing chamber 203a may have an ftc-first inlet 230a for the heated water and an ftc-second inlet 231a for the heated water, and an ftc-outlet 232a for removing heated water and water vapor from the first testing chamber 203a. In an aspect, the ftc-first and ftc-second inlets 230a and 231a may be jet nozzles.

In this aspect, the second testing chamber 203b may have a stc-support 213b for holding a second device under test 201b, e.g., a die. The second device 201b may have one or more second resistance temperature detectors (RTD) 202b for providing temperature measures for the second device 201b while it is being tested. The second RTD 202b may be also coupled with the temperature monitor (not shown), which may be part of the testing system 200. The second testing chamber 203b may have a stc-first inlet 230b for the heated water and a stc-second inlet 231b for the heated water, and a stc-outlet 232b for removing heated water and water vapor from the second testing chamber 203b. In an aspect, the stc-first and stc-second inlets 230b and 231b may be jet nozzles.

In this aspect, the testing system 200 may have a water circulation system for conveying heated water to the first and second testing chambers 203a and 203b, respectively. A water reservoir 207 may have a first pump 210, which may be a vacuum pump that controls the pressure in the water reservoir 207, and a first conduit 220 connected to a second pump 211 that moves the water under pressure to a filter 209, a flow meter 204 and a water heater 205 (also presently referred to as the primary water heater). The water heater 205 may provide heated water to a first section of water conduits of the water circulation system that includes a second conduit 221a, a third conduit 222a, a fourth conduit 223a, and a fifth conduit 224a.

In this aspect, the third conduit 222a may have a first valve 240a that controls the flow of heated water into the ftc-first inlet 230a. The fourth conduit 223a, which may be configured as a bypass that leads from the third conduit 222a, may have a proportional valve 242a that controls the flow of a “secondary” heated water into the ftc-second inlet 231a. The fourth conduit 223a may have a small cross-sectional area (e.g., a one-quarter inch or less) for the flow of heated water and may be positioned to ensure the highest possible temperature, which will translate to a higher vapor quality (i.e., vapor content) and a faster test response. In addition, the fourth conduit 223a may be optionally provided with an auxiliary or ftc-secondary water heater 206a to provide additional heating for the secondary heated water. The secondary heated water may be used to modulate, i.e., increase or decrease, the saturation temperature and pressure in the first testing chamber 203a. The fifth conduit 224a may have a shutoff valve 241a that controls the flow of heated water and water vapor that may be removed from the first testing chamber 203a. In another aspect, as an option, the shutoff valve 241a may be used to restrict the flow and enhance the response time and may include either a proportional valve or other control valve.

In a further aspect, the water heater 205 may provide heated water to an extension to the first section of water conduits of the water circulation system that includes an extension second conduit 221b an extension third conduit 222b, an extension fourth conduit 223b, and an extension fifth conduit 224b that may be connected to the second testing chamber 203b. In this further aspect, the extension third conduit 222b may have an extension first valve 240b that controls the flow of heated water into the stc-first inlet 230b. The extension fourth conduit 223b, which may be configured as a bypass that leads from the extension third conduit 222b, may have an extension proportional valve 242b that controls the flow of a “secondary” heated water into the stc-second inlet 231b. The extension fourth conduit 223b may have a small cross-sectional area (e.g., a one-quarter inch or less) for the flow of heated water and may be positioned to ensure the highest possible temperature, which will translate to a higher vapor quality (i.e., vapor content) and a faster test response. In addition, the extension fourth conduit 223b may be optionally provided with an auxiliary or stc-secondary water heater 206b to provide additional heating for the secondary heated water for the second testing chamber 203b. The secondary heated water may be used to modulate, i.e., increase or decrease, the saturation temperature and pressure in the second testing chamber 203b. The extension fifth conduit 224b may have an extension shutoff valve 241b that controls the flow of heated water and water vapor that may be removed from the second testing chamber 203b. In another aspect, as an option, the extension shutoff valve 241b may be used to restrict the flow and enhance the response time and may include either a proportional valve or other control valve.

In this aspect, the testing system 200 may have a water circulation system for conveying cooling water. The water reservoir 207 may be coupled to a second section of water conduits of the water circulation system that includes a sixth conduit 225 connected to a third pump 212 that moves the water under pressure to a cooler 208, which cools the water, a seventh conduit 226a, a bypass conduit 227a that joins with the fifth conduit 224a, and an eighth conduit 228a that returns the water to the water reservoir 207. In addition, an extension to the second section of water conduits of the water circulation system may include an extension seventh conduit 226b that joins with the extension fifth conduit 224b and an extension eighth conduit 228b that connects with the eighth conduit 228a. The heated water and water vapor being removed from the first testing chamber 203a by the fifth conduit 224a and the second testing chamber 203b by the extension fifth conduit 224b may be cooled and condensed in the eighth conduit 228a and the extension eighth conduit 228b by the cooling water from the extension seventh conduit 226b and the bypass conduit 227a.

As shown in FIG. 2, the extensions to the first and second sections of water conduits of the water circulation system allow the second testing chamber 203b to be placed in a parallel configuration with the first testing chamber 203a. It should be understood that a two-phase jet impingement testing system having a plurality of testing chambers need not be limited to a parallel configuration, and for example, a hub-type configuration may also be used.

In this aspect, the testing system 200 may have a control system (not shown) for monitoring and controlling the pressure in the first and second testing chambers 203a and 203b, respectively, as well as throughout the testing system, using a plurality of pressure sensors. For example, as shown in FIG. 2, the water reservoir 207 may have a pressure sensor 218, the first conduit 220 may have a first pressure gauge 219, the second conduit 221a may have a second pressure gauge 215a, the extension second conduit 221b may have an extension second pressure gauge 215b, the first testing chamber 203a may have an ftc-third pressure gauge 216a, the second testing chamber 203a may have an stc-third pressure gauge 216b, and the eight conduit 228a may have a fourth pressure gauge 217a, and the extension eight conduit 228b may have an extension fourth pressure gauge 217b. It should be understood that additional pressure gauges may be placed in a testing system as may be needed by a specific testing system design. In addition, the control system may monitor and control the temperature throughout the testing system 200 using the heater 205, the cooler 208, and the first testing chamber 203a using the first valve 240a, the shutoff valve 241a, and proportional valve 242a, and the second testing chamber 203b using the extension first valve 240b, the extension shutoff valve 241b and extension proportional valve 242b.

As shown in FIG. 2, for the present two-phase jet impingement testing system 200 having a design with two testing chambers 203a and 203b running in parallel, the two testing chambers 203a and 203b may be independently controlled with different water vapor quality inside each testing chamber. The first and second testing chambers 203a and 203b may be modulated by the secondary heated water conveyed via the fourth conduits 223a and 223b (i.e., as heated water bypasses), which are controlled by proportional valves 242a and 242b. The common inline condensation system, i.e., the second section of water conduits of the water circulation system, can ensure that the water vapor is condensed at the exit of each testing chamber. Although each of the first and second testing chambers 203a and 203b, respectively, can exist at different saturation temperatures/pressures, the shared water reservoir 207 may have a pressure that is independent of them.

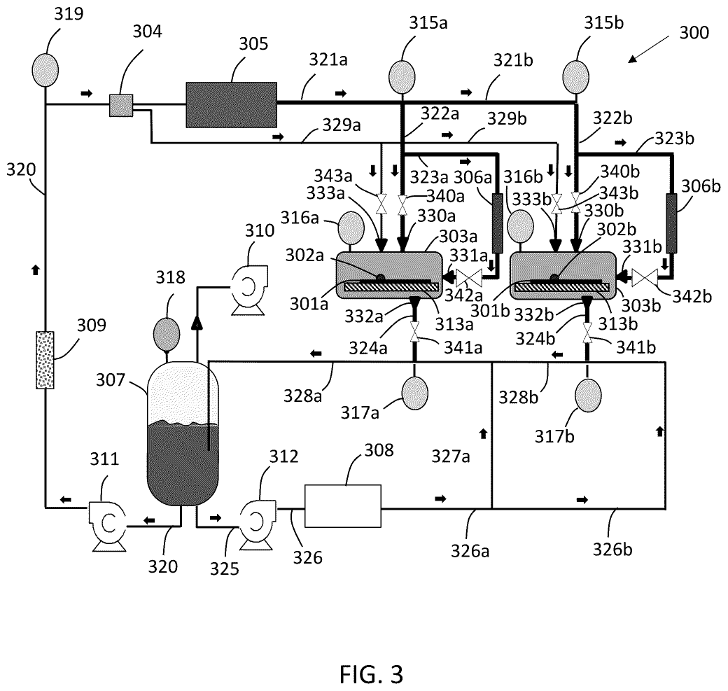

FIG. 3 shows an exemplary representation of a two-phase jet impingement testing system 300 having a plurality of testing chambers according to another aspect of the present disclosure. For example, the two-phase jet impingement testing system 300 may include a first testing chamber (ftc) 303a and a second testing chamber (stc) 303b. In this aspect, the first testing chamber 303a may have an ftc-support 313a for holding a first device under test 301a, e.g., a die. The first device 301a may have one or more first resistance temperature detectors (RTD) 302a for providing temperature measures for the first device 301a while it is being tested. The first RTD 302a may be coupled with a temperature monitor (not shown), which may be part of the testing system 300. The first testing chamber 303a may have an ftc-first inlet 330a for the heated water, an ftc-second inlet 331a for the heated water, an ftc-third inlet 331a for cooling water, and an ftc-outlet 332a for removing heated water and water vapor from the first testing chamber 303a. In an aspect, the ftc-first and ftc-second inlets 330a and 331a, respectively, may be jet nozzles.

In this aspect, the second testing chamber 303b may have a stc-support 313b for holding a second device under test 301b, e.g., a die. The second device 301b may have one or more second resistance temperature detectors (RTD) 302b for providing temperature measures for the second device 301b while it is being tested. The second RTD 302b may be also coupled with the temperature monitor (not shown), which may be part of the testing system 300. The second testing chamber 303b may have a stc-first inlet 330b for the heated water, a stc-second inlet 331b for the heated water, a stc-third inlet 333b for cooling water, and an stc-outlet 332b for removing heated water and water vapor from the second testing chamber 303b. In an aspect, the stc-first and stc-second inlets 330b and 331b may be jet nozzles.

In this aspect, the testing system 300 may have a water circulation system for conveying heated water to the first and second testing chambers 303a and 303b, respectively. A water reservoir 307 may have a first pump 310, which may be a vacuum pump that controls the pressure in the water reservoir 307, and a first conduit 320 connected to a second pump 311 that moves the water under pressure to a filter 309, a flow meter 304 and a water heater 305 (also presently referred to as the primary water heater). The water heater 305 may provide heated water to a first section of water conduits of the water circulation system that includes a second conduit 321a, a third conduit 322a, a fourth conduit 323a, and a fifth conduit 324a.

In this aspect, the third conduit 322a may have a first mixing valve 340a that controls the flow of heated water into the first inlet 330a. The fourth conduit 323a, which may be configured as a bypass that leads from the third conduit 322a, may have a proportional valve 342a that controls the flow of a “secondary” heated water into the second inlet 331a. The fourth conduit 323a may have a small cross-sectional area (e.g., a one-quarter inch or less) for the flow of heated water and may be positioned to ensure the highest possible temperature, which will translate to a higher vapor quality (i.e., vapor content) and a faster test response. In addition, the fourth conduit 323a may be optionally provided with an auxiliary or secondary water heater 306a to provide additional heating for the secondary heated water. The secondary heated water may be used to modulate, i.e., increase or decrease, the saturation temperature and pressure in the first testing chamber 303a. The fifth conduit 324a may have a shutoff valve 341a that controls the flow of heated water and water vapor that may be removed from the first testing chamber 303a. In another aspect, as an option, the shutoff valve 341a may be used to restrict the flow and enhance the response time and may include either a proportional valve or other control valve.

In a further aspect, the water heater 305 may provide heated water to an extension to the first section of water conduits of the water circulation system that includes an extension second conduit 321b an extension third conduit 322b, an extension fourth conduit 323b, and an extension fifth conduit 324b that may be connected to the second testing chamber 303b. In this further aspect, the extension third conduit 322b may have an extension first mixing valve 340b that controls the flow of heated water into the stc-first inlet 330b. The extension fourth conduit 323b, which may be configured as a bypass that leads from the extension third conduit 322b, may have an extension proportional valve 342b that controls the flow of a “secondary” heated water into the stc-second inlet 331b. The extension fourth conduit 323b may have a small cross-sectional area (e.g., a one-quarter inch or less) for the flow of heated water and may be positioned to ensure the highest possible temperature, which will translate to a higher vapor quality (i.e., vapor content) and a faster test response. In addition, the extension fourth conduit 323b may be optionally provided with an auxiliary or stc-secondary water heater 306b to provide additional heating for the secondary heated water for the second testing chamber 303b. The secondary heated water may be used to modulate, i.e., increase or decrease, the saturation temperature and pressure in the testing chamber 303b. The extension fifth conduit 324b may have an extension shutoff valve 341b that controls the flow of heated water and water vapor that may be removed from the second testing chamber 303b. In another aspect, as an option, the extension shutoff valve 341b may be used to restrict the flow and enhance the response time and may include either a proportional valve or other control valve.

In this aspect, the testing system 300 may have a water circulation system for conveying cooling water. The water reservoir 307 may be coupled to a second section of water conduits of the water circulation system that includes a sixth conduit 325 connected to a third pump 312 that moves the water under pressure to a cooler 308, which cools the water, a seventh conduit 326a, a bypass conduit 327a that joins with the fifth conduit 324a, and an eighth conduit 328a that returns the water to the water reservoir 307. In addition, an extension to the second section of water conduits of the water circulation system may include an extension seventh conduit 326b that joins with the extension fifth conduit 324b and an extension eighth conduit 328b that connects with the eighth conduit 328a. The heated water and water vapor being removed from the first testing chamber 303a by the fifth conduit 324a and the second testing chamber 303b by the extension fifth conduit 324b may be cooled and condensed in the eighth conduit 328a and the extension eighth conduit by the cooling water from the extension seventh conduit 326b and the bypass conduit 327a.

In this aspect, the water circulation system may include a third section of water conduits for conveying cooling water. The third section of water conduits of the water circulation system may include a ninth conduit 329a. The ninth conduit 329a extends from the flow meter 304 to the ftc-third inlet 333a of the first testing chamber 303a. The flow of cooling water in the ninth conduit 329a may be controlled by an ftc-second mixing valve 343a. In addition, an extension to the third section of water conduits of the water circulation system may include an extension ninth conduit 329b, which extends from the ninth conduit 329a, and connects to the stc-third inlet 333b of the second testing chamber 303b. The flow of cooling water in the extension ninth conduit 329b may be controlled by a stc-second mixing valve 343b.

In this aspect, the heated water from the ftc-first inlet 330a and the cooling water from the ftc-third inlet 333a are mixed to achieve a desired inlet temperature before entering the first testing chamber 303a, with added secondary heated water from ftc-second inlet 331a being used to modulate the saturation temperature and pressure in the first testing chamber 303a. Similarly, the heated water from the stc-first inlet 330b and the cooling water from the stc-third inlet 333b are mixed to achieve the desired inlet temperature before entering the second testing chamber 303b, with added secondary heated water from the stc-second inlet 331b being used to modulate the saturation temperature and pressure in the second testing chamber 303b.

As shown in FIG. 3, the extensions to the first and second sections of water conduits of the water circulation system allow the second testing chamber 303b to be placed in a parallel configuration with the first testing chamber 303a. It should be understood that a two-phase jet impingement testing system having a plurality of testing chambers need not be limited to a parallel configuration, and for example, a hub-type configuration may also be used.

In this aspect, the testing system 300 may have a control system (not shown) for monitoring and controlling the pressure in the first and second testing chambers 303a and 303b, respectively, as well as throughout the testing system, using a plurality of pressure sensors. For example, as shown in FIG. 3, the water reservoir 307 may have a pressure sensor 318, the first conduit 320 may have a first pressure gauge 319, the second conduit 321a may have a second pressure gauge 315a, the extension second conduit 321b may have an extension second pressure gauge 315b, the first testing chamber 303a may have an ftc-third pressure gauge 316a, the second testing chamber 303a may have an stc-third pressure gauge 316b, and the eight conduit 328a may have a fourth pressure gauge 317a, and the extension eight conduit 328b may have an extension fourth pressure gauge 317b. It should be understood that additional pressure gauges may be placed in a testing system as may be needed by a specific testing system design.

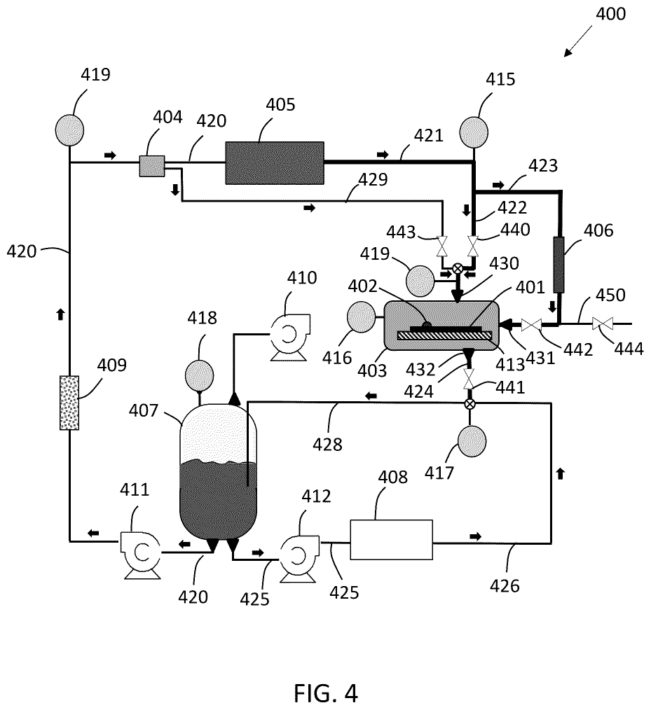

FIG. 4 shows an exemplary representation of a two-phase jet impingement testing system 400 according to another aspect of the present disclosure. In this aspect, the two-phase jet impingement testing system 400 may have a testing chamber 403 with a support 413 for holding a device under test 401, e.g., a die. The device 401 may have one or more resistance temperature detectors (RTD) 402 for providing temperature measures for the device 401 while it is being tested. The RTD 402 may be coupled with a temperature monitor (not shown), which may be part of the testing system 400. The testing chamber 403 may have a first inlet 430 for the heated water, a second inlet 431 for the heated water, and an outlet 432 for removing heated water and water vapor from the testing chamber 403.

In this aspect, the testing system 400 may have a water circulation system for conveying heated water. A water reservoir 407 may have a first pump 410, which may be a vacuum pump that controls the pressure in the water reservoir 407, and a first conduit 420 connected to a second pump 411 that moves the water under pressure to a filter 409, a flow meter 404 and a water heater 405 (also presently referred to as the primary water heater). The water heater 405 may provide heated water to a first section of water conduits of the water circulation system that includes a second conduit 421, a third conduit 422, a fourth conduit 423, and a fifth conduit 424.

In this aspect, the third conduit 422 may have a first mixing valve 440 that controls the flow of heated water before it is mixed with cooling water from a third section of water conduits of the water circulation system. The fourth conduit 423, which may be configured as a bypass that leads from the third conduit 422, may have a proportional valve 442 that controls the flow of a “secondary” heated water into the second inlet 431. The fourth conduit 423 may have a small cross-sectional area (e.g., a one-quarter inch or less) for the flow of heated water and may be positioned to ensure the highest possible temperature, which will translate to a higher vapor quality (i.e., vapor content) and a faster test response. In addition, the fourth conduit 423 may be optionally provided with an auxiliary or secondary water heater 406 to provide additional heating for the secondary heated water. The secondary heated water may be used to modulate, i.e., increase or decrease, the saturation temperature and pressure in the testing chamber 403. The fifth conduit 424 may have a shutoff valve 441 that controls the flow of heated water and water vapor that may be removed from the testing chamber 403. In another aspect, as an option, the shutoff valve 441 may be used to restrict the flow and enhance the response time and may include either a proportional valve or other control valve.

In this aspect, the testing system 400 may have a water circulation system for conveying cooling water. The water reservoir 407 may be coupled to a second section of water conduits of the water circulation system that includes a sixth conduit 425 connected to a third pump 412 that moves the water under pressure to a cooler 408, which cools the water, a seventh conduit 426 that joins with the fifth conduit 424, and an eighth conduit 428 that returns the water to the water reservoir 407. The heated water and water vapor are removed from the testing chamber 403 by the fifth conduit 424 and may be cooled and condensed in the eighth conduit 428 by the cooling water from the seventh conduit 426.

In this aspect, the water circulation system may include the third section of water conduits for conveying cooling water. The third section of water conduits of the water circulation system may include a ninth conduit 429. The ninth conduit 429 extends from the flow meter 404 to join with the third conduit 422 to the first inlet 430 of the testing chamber 403. The flow of cooling water in the ninth conduit 429 may be controlled by a second mixing valve 443 and is mixed with the heated water from the third conduit 422 to provide a mixed cooler heated water to achieve a desired heated water temperature before entering the testing chamber 403.

In this aspect, the testing system 400 may have a control system for monitoring and controlling the pressure in the testing chamber, as well as throughout the testing system, using a plurality of pressure sensors. For example, as shown in FIG. 4, the water reservoir 407 may have a pressure sensor 418, the first conduit 420 may have a first pressure gauge 419, the second conduit 421 may have a second pressure gauge 415, the testing chamber 403 may have a third pressure gauge 416, and the eighth conduit 428 may have a fourth pressure gauge 417. It should be understood that additional pressure gauges may be placed in a testing system as may be needed by a specific system design. In addition, the control system may monitor and control the temperature throughout the testing system 400 using the heater 405, the cooler 408, and the testing chamber 403 using the first mixing valve 440 and second mixing valve 443, the shutoff valve 441, and proportional valve 442.

In another aspect, the second inlet 431 may also be used as a purge port to minimize the number of ports in the chamber and connected by an air purge conduit 450, which may have an air shutoff valve 444.

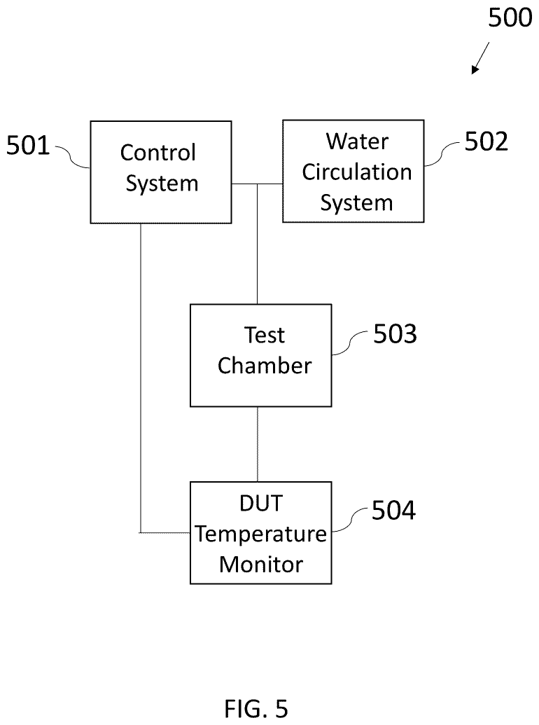

FIG. 5 shows an exemplary system-level representation of a system two-phase jet impingement testing 500 according to an aspect of the present disclosure. In this aspect, a control system 501, which may be configured to monitor and control temperature and pressure in a testing chamber 503. In this aspect, a water circulation system 502 may be configured to convey pressurized heated water, which may produced by a primary water heater (not shown), and also convey cooling water. The control system 501 may modulate, i.e., increase and/or decrease, the saturation temperature and pressure in the testing chamber 503 using the heated water from the water circulation system 502. For a device under test (DUT), a DUT temperature monitor 504 may be configured to couple with a temperature sensor disposed on the device (not shown). In an aspect, the DUT temperature monitor 504 may be disposed on the DUT. It may also be possible for the control system 501 to calculate a saturation temperature based on a saturation pressure in the testing chamber 503.

It should be understood that the present testing systems may have vacuum components (not shown) to pump down a testing chamber before the testing of a DUT and other cleaning and pumping components (not shown) to purge the testing chamber after the testing of the DUT.

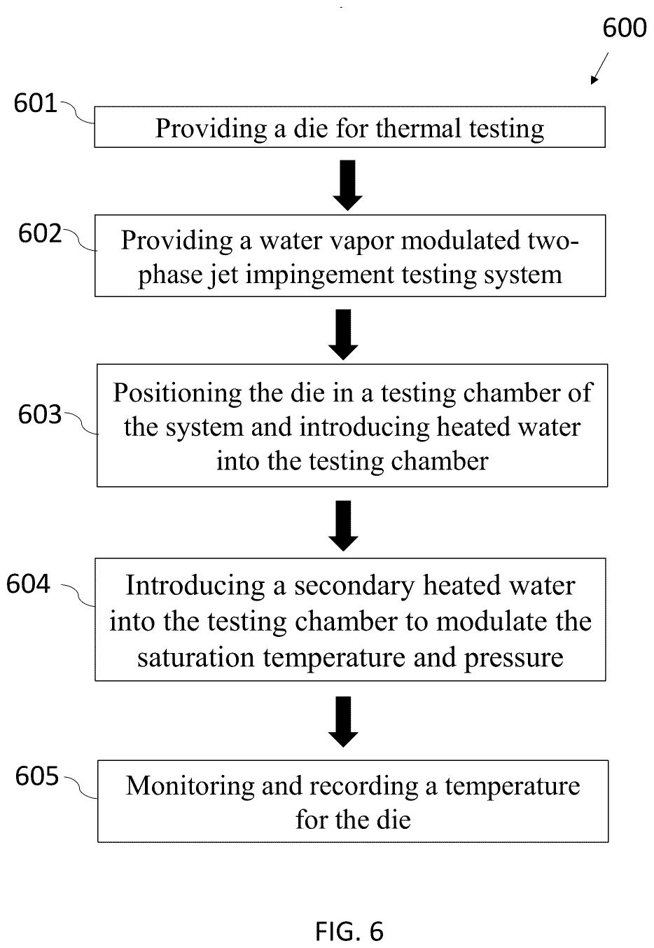

FIG. 6 shows a simplified flow diagram for an exemplary method 600 according to an aspect of the present disclosure.

The operation 601 may be directed to providing a die for thermal testing.

The operation 602 may be directed to providing a water vapor-modulated two-phase jet impingement testing system.

The operation 603 may be directed to positioning the die in a testing chamber of the system and introducing heated water into the testing chamber.

The operation 604 may be directed to introducing a secondary heated water into the testing chamber to modulate the saturation temperature and pressure.

The operation 605 may be directed to monitoring and recording a temperature for the die.

It will be understood that any property described herein for a particular two-phase jet impingement testing system and method for its use may also hold for any two-phase jet impingement testing system using the present modulated saturation pressure and temperature described herein. It will also be understood that any property described herein for a specific method may hold for any of the methods described herein. Furthermore, it will be understood that for any two-phase jet impingement testing system and the methods described herein, not necessarily all the components or operations described will be shown in the accompanying drawings or method, but only some (not all) components or operations may be disclosed.

To more readily understand and put into practical effect the two-phase jet impingement testing system having the present secondary heater for modulation of the saturation pressure and temperature, they will now be described by way of examples. For the sake of brevity, duplicate descriptions of features and properties may be omitted.

### EXAMPLES

Example 1 provides a testing system including a water circulation system configured to convey heated water, a primary water heater configured to provide the heated water, a testing chamber connected to the water circulation system, for which the testing chamber includes a support for a device under test, a first inlet configured to introduce heated water from the primary water heater into the testing chamber, a second inlet configured to introduce secondary heated water from the primary water heater into the testing chamber, and a first outlet configured to remove heated water from the testing chamber. In an aspect, the testing system includes a control system having a controller and sensors that are configured to monitor and control temperature and pressure in the testing chamber, for which a saturation temperature and a saturation pressure are increased in the testing chamber by the control system using the secondary heated water, and a temperature monitor configured to couple with a temperature sensor disposed on the device under test.

Example 2 may include the testing system of example 1 and/or any other example disclosed herein, for which the water circulation system includes a first section of water conduits for conveying the heated water, for which the first section includes a first set of water conduits configured to connect the primary water heater to the first inlet of the testing chamber, and a second set of water conduits configured as a bypass to connect the primary water heater to the second inlet of the testing chamber, for which a first end of the second set of water conduits connects to an upstream section of the first set of water conduits and a second end of the second set of water conduits connects to the second inlet.

Example 3 may include the testing system of example 2 and/or any other example disclosed herein, which further includes a secondary heater configured to provide additional heating for the secondary heated water, for which the secondary heater is positioned between the primary heater and the second inlet and is coupled by the second set of water conduits to the testing chamber.

Example 4 may include the testing system of example 1 and/or any other example disclosed herein, for which the water circulation system includes a water reservoir connected to a water cooler configured to provide the cooling water and a second section of water conduits for conveying cooling water, for which the second section of water conduits includes a third set of water conduits configured to circulate the cooling water and connect the water cooler with the first outlet of the testing chamber to enable the heated water removed from the testing chamber via the first outlet to combine with the cooling water.

Example 5 may include the testing system of example 3 and/or any other example disclosed herein, for which The testing system of claim 3, for which the testing chamber further includes a third inlet configured to introduce the cooling water into the testing chamber, and for which the water circulation system further includes a third section of water conduits for conveying cooling water, for which the third section of water conduits includes a fourth set of water conduits, for which the fourth set of water conduits is configured to connect the water reservoir to the third inlet of the testing chamber.

Example 6 may include the testing system of example 3 and/or any other example disclosed herein, for which the water circulation system includes a third section of water conduits section of water conduits for conveying the cooling water, for which the third section of water conduits includes a fourth set of water conduits configured to introduce the cooling water into the testing chamber, for which the fourth set of water conduits is configured to connect with the first set of water conduits to combine the cooling water from the water reservoir with the heated water from the primary water heater to introduce a mixed cooler heated water into the testing chamber.

Example 7 may include the testing system of example 1 and/or any other example disclosed herein, for which the water circulation system further includes mixing valves, proportional valves, and shutoff valves.

Example 8 may include the testing system of example 3 and/or any other example disclosed herein, for which the water circulation system further includes a water filter, a flow meter, and a plurality of pumps.

Example 9 may include the testing system of example 1 and/or any other example disclosed herein, for which the controller of the control system is coupled to a plurality of pressure sensors and gauges, temperature sensors that are connected to the water circulation system, and the testing chamber.

Example 10 provides a method including providing a die for thermal testing, providing a testing system, for which the testing system includes a testing chamber with a support for the die, a water circulation system configured to convey pressurized heated water and cooling water, a primary water heater for producing the heated water connected by a first section of water conduits of the water circulation system to the testing chamber, and a control system configured for monitoring and controlling temperature and pressure in the testing system, In an aspect, the method also includes positioning the die in the testing chamber on the support and introducing heated water from the primary water heater into the testing chamber, monitoring and controlling temperature and pressure in the testing chamber and introducing secondary heated water from the primary water heater to control a saturation temperature and pressure for the heated water in the testing chamber, and monitoring and recording a temperature for the die.

Example 11 may include the method of example 10 and/or any other example disclosed herein, for which the testing chamber includes a plurality of testing chambers that are connected by the water circulation system in a parallel configuration, and for which the die includes a plurality of dies, for which each of the plurality of testing chambers is provided with one of the plurality of dies.

The method of claim 11, for which the monitoring and controlling temperature and pressure and the introduction of the secondary heated water to control the saturation temperature and the saturation pressure for the heated water is performed independently for each of the plurality of testing chambers.

The method of claim 10, for which the testing system further includes a secondary heater positioned between the primary heater and the testing chamber and coupled with the water circulation system, and for which the method further includes using the secondary heater to provide additional heating for the secondary heated water before introduction into the testing chamber.

The method of claim 10, for which the water circulation system further includes a second section of water conduits for conveying cooling water, and for which the method further includes removing heated water from the testing chamber and combining the removed heated water with the cooling water in the second section of water conduits of the water circulation system.

Example 15 provides a testing system including a water circulation system configured to convey heated water and cooling water, a primary water heater and a plurality of secondary water heaters configured to provide the heated water, a plurality of testing chambers connected by the water circulation system, for which each testing chamber includes a support for a die under test, a first inlet configured to introduce heated water from the primary water heater into the testing chamber, a second inlet configured to introduce a secondary heated water into the testing chamber, for which the secondary heated water is heated by one of the plurality of secondary water heaters that is paired with the testing chamber, and a first outlet configured to remove heated water and water vapor from the testing chamber. In an aspect, the testing system also includes a control system having a controller and sensors that are configured to monitor and control temperature and pressure in the plurality of testing chambers, for which a saturation temperature and pressure in each of the testing chambers are independently controlled by the control system, and a temperature monitor configured to be coupled with a temperature sensor disposed on the die under test.

Example 16 may include the testing system of example 15 and/or any other example disclosed herein, for which the water circulation system includes a first section of water conduits for conveying the heated water, for which the first section of water conduits includes a plurality of first set of water conduits, for which each of the first set of water conduits is configured to connect the primary water heater to the first inlets of each of the plurality of testing chambers, and a plurality of second set of water conduits, for which each of the second set of water conduits is configured to connect each of the plurality secondary water heaters to the second inlets of their respective testing chambers.

Example 17 may include the testing system of example 16 and/or any other example disclosed herein, for which the water circulation system includes a water reservoir connected to a water cooler and a second section of water conduits for conveying the cooling water, for which the second section includes, and a plurality of third set of water conduits configured to circulate the cooling water and connect the water cooler to the first outlets of the testing chambers to enable the removed heated water from the testing chambers to combine with the cooling water.

Example 18 may include the testing system of example 17 and/or any other example disclosed herein, for which each of the plurality of testing chambers further includes a third inlet configured to introduce the cooling water into each of the plurality of testing chambers, and for which the water circulation system includes a third section of water conduits for conveying the cooling water, for which the third section includes a plurality of fourth set of water conduits, for which each of the fourth set of water conduits is configured to connect the water reservoir to each of the third inlets of the plurality of the testing chambers.

Example 19 may include the testing system of example 15 and/or any other example disclosed herein, for which the plurality of testing chambers are connected by the water circulation system in a parallel configuration.

Example 20 may include the testing system of example 15 and/or any other example disclosed herein, for which the control system is configured to independently introduce the secondary heated water from the secondary water heater for each of the plurality of testing chambers.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The terms “and” and “or” herein may be understood to mean “and/or” as including either or both of two stated possibilities.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. A testing system comprising:
a water circulation system configured to convey heated water;
a primary water heater configured to provide the heated water;
a testing chamber connected to the water circulation system, wherein the testing chamber comprises a support for a device under test, a first inlet configured to introduce heated water from the primary water heater into the testing chamber, a second inlet configured to introduce secondary heated water from the primary water heater into the testing chamber, and a first outlet configured to remove heated water from the testing chamber;
a control system having a controller and sensors that are configured to monitor and control temperature and pressure in the testing chamber, wherein a saturation temperature and a saturation pressure are increased in the testing chamber by the control system using the secondary heated water; and
a temperature monitor configured to couple with a temperature sensor disposed on the device under test.

2. The testing system of claim 1, wherein the water circulation system comprises a first section of water conduits for conveying the heated water, wherein the first section of water conduits comprises:
a first set of water conduits configured to connect the primary water heater to the first inlet of the testing chamber; and
a second set of water conduits configured to connect the primary water heater to the second inlet of the testing chamber, wherein a first end of the second set of water conduits connects to an upstream section of the first set of water conduits and a second end of the second set of water conduits connects to the second inlet.

3. The testing system of claim 2, further comprises a secondary heater configured to provide additional heating for the secondary heated water, wherein the secondary heater is positioned between the primary heater and the second inlet and is coupled by the second set of water conduits to the testing chamber.

4. The testing system of claim 1, wherein the water circulation system comprises a water reservoir connected to a water cooler configured to provide the cooling water and a second section of water conduits for conveying cooling water, wherein the second section comprises:
a third set of water conduits configured to circulate the cooling water and connect the water cooler with the first outlet of the testing chamber to enable the heated water removed from the testing chamber via the first outlet to combine with the cooling water.

5. The testing system of claim 3, wherein the testing chamber further comprises a third inlet configured to introduce the cooling water into the testing chamber; and wherein the water circulation system further comprises a third section of water conduits for conveying cooling water, wherein the third section comprises a fourth set of water conduits, wherein the fourth set of water conduits is configured to connect the water reservoir to the third inlet of the testing chamber.

6. The testing system of claim 3, wherein the water circulation system comprises a third section of water conduits for conveying the cooling water, wherein the third section comprises:
a fourth set of water conduits configured to introduce the cooling water into the testing chamber, wherein the fourth set of water conduits is configured to connect with the first set of water conduits to combine the cooling water from the water reservoir with the heated water from the primary water heater to introduce a mixed cooler heated water into the testing chamber.

7. The testing system of claim 1, wherein the water circulation system further comprises mixing valves, proportional valves, and shutoff valves.

8. The testing system of claim 3, wherein the water circulation system further comprises a water filter, a flow meter, and a plurality of pumps.

9. The testing system of claim 1, wherein the controller of the control system is coupled to a plurality of pressure sensors and gauges, temperature sensors that are connected to the water circulation system and the testing chamber.

10. A method comprising:
providing a die for thermal testing;
providing a testing system, wherein the testing system comprises:
a testing chamber with a support for the die, a water circulation system configured to convey pressurized heated water and cooling water, a primary water heater for producing the heated water connected by a first section of water conduits to the testing chamber, and a control system configured for monitoring and controlling temperature and pressure in the testing system;
positioning the die in the testing chamber on the support and introducing heated water from the primary water heater into the testing chamber;
monitoring and controlling temperature and pressure in the testing chamber and introducing secondary heated water from the primary water heater to control a saturation temperature and pressure for the heated water in the testing chamber; and
monitoring and recording a temperature for the die.

11. The method of claim 10, wherein the testing chamber comprises a plurality of testing chambers that are connected by the water circulation system in a parallel configuration, and wherein the die comprises a plurality of dies, wherein each of the plurality of testing chambers is provided with one of the plurality of dies.

12. The method of claim 11, wherein the monitoring and controlling temperature and pressure and the introduction of the secondary heated water to control the saturation temperature and the saturation pressure for the heated water is performed independently for each of the plurality of testing chambers.

13. The method of claim 10, wherein the testing system further comprises a secondary heater positioned between the primary heater and the testing chamber and coupled with the water circulation system; and wherein the method further comprises using the secondary heater to provide additional heating for the secondary heated water before introduction into the testing chamber.

14. The method of claim 10, wherein the water circulation system further comprises a second section of water conduits for conveying cooling water, and wherein the method further comprises removing heated water from the testing chamber and combining the removed heated water with the cooling water in the second section of water conduits of the water circulation system.

15. A testing system comprising:
a water circulation system configured to convey heated water and cooling water;
a primary water heater and a plurality of secondary water heaters configured to provide the heated water;
a plurality of testing chambers connected by the water circulation system, wherein each testing chamber comprises:
a support for a die under test;
a first inlet configured to introduce heated water from the primary water heater into the testing chamber, a second inlet configured to introduce a secondary heated water into the testing chamber, wherein the secondary heated water is heated by one of the plurality of secondary water heaters that is paired with the testing chamber, and a first outlet configured to remove heated water and water vapor from the testing chamber;
a control system having a controller and sensors that are configured to monitor and control temperature and pressure in the plurality of testing chambers, wherein a saturation temperature and pressure in each of the testing chambers are independently controlled by the control system; and
a temperature monitor configured to be coupled with a temperature sensor disposed on the die under test.

16. The testing system of claim 15, wherein the water circulation system comprises a first section of water conduits for conveying the heated water, wherein the first section of water conduits comprises:
a plurality of first set of water conduits, wherein each of the first set of water conduits is configured to connect the primary water heater to the first inlets of each of the plurality of testing chambers; and
a plurality of second set of water conduits, wherein each of the second set of water conduits is configured to connect each of the plurality secondary water heaters to the second inlets of their respective testing chambers.

17. The testing system of claim 16, wherein the water circulation system comprises a water reservoir connected to a water cooler and a second section of water conduits for conveying the cooling water, wherein the second section of water conduits comprises:
a plurality of third set of water conduits configured to circulate the cooling water and connect the water cooler to the first outlets of the testing chambers to enable the removed heated water from the testing chambers to combine with the cooling water.

18. The testing system of claim 17, wherein each of the plurality of testing chambers further comprises a third inlet configured to introduce the cooling water into each of the plurality of testing chambers; and
wherein the water circulation system comprises a third section of water conduits for conveying the cooling water, wherein the third section of water conduits comprises:
a plurality of fourth set of water conduits, wherein each of the fourth set of water conduits is configured to connect the water reservoir to each of the third inlets of the plurality of the testing chambers.

19. The testing system of claim 15, wherein the plurality of testing chambers are connected by the water circulation system in a parallel configuration.

20. The testing system of claim 15, wherein the control system is configured to independently introduce the secondary heated water from the secondary water heater for each of the plurality of testing chambers.
